(19) United States
(12) Patent Application Publication
(10) Pub. No.: US 2025/0328921 A1
(43) Pub. Date: Oct. 23, 2025

(54) USING SMART CONTRACTS TO CONTROL AUTOMATIC DISTRIBUTION OF PRODUCTION INSTRUCTIONS

(71) Applicant: Kornit Digital Ltd., Rosh HaAyin (IL)

(72) Inventors: Jacob MANN, Zoran (IL); Omer KULKA, Tel Aviv (IL); Michael GRUZBERG, Pardes Hana-Karkur (IL)

(73) Assignee: Kornit Digital Ltd., Rosh HaAyin (IL)

(21) Appl. No.: 18/870,416

(22) PCT Filed: May 24, 2023
(86) PCT No.: PCT/IL2023/050541

§ 371 Date: Nov. 28, 2024

Related U.S. Application Data
(60) Provisional application No. 63/346,929, filed on May 30, 2022.

(51) Int. Cl. G06Q 30/018; G06Q 30/0601; G06Q 50/04; H04L 9/08

(52) U.S. Cl. CPC G06Q 30/0185; G06Q 30/0643; G06Q 50/04; H04L 9/0825; G06Q 2220/00

(57) ABSTRACT

Disclosed herein are methods and systems for generating smart contracts configured to distribute production instructions of physical items based on authentication of ownership of a corresponding digital assets, comprising receiving requests from one or more client devices used by respective users to produce one or more physical items corresponding to digital assets of the users, transmitting to the client device of each user a key uniquely associated with the digital assets, and generating a smart contract associating production instructions for producing the one or more physical items with respective unique keys. The smart contract is configured to provide the production instructions to the one or more users based on authentication of their unique key such that the users interacting with the smart contract use their unique keys to authenticate their ownership of their digital assets and receive the production instructions for producing the physical items.

### RELATED APPLICATIONS

This application claims the benefit of priority under 35 USC § 119 (e) of U.S. Provisional Patent Application No. 63/346,929 filed on May 30, 2022, the contents of which are all incorporated by reference as if fully set forth herein in their entirety.

### FIELD AND BACKGROUND OF THE INVENTION

The present invention, in some embodiments thereof, relates to generating smart contracts to control distribution of production instructions for producing physical items for users based on verification of ownership of corresponding digital assets by the users.

The virtual domain has rapidly expanded in recent years with the rise of numerous virtual environments, virtual worlds and/or the like, such as, for example, Metaverse, Robolox, Fortnite, OpenSea, Decentraland to name just a few.

One major characteristic of the virtual domain is the existence and use of digital content which may be purchased, exchanged and/or otherwise transferred between users, consumers, publishers, sellers, and/or the like. The digital content may comprise, for example, designs, pictures, drawings, symbols, icons, texts, slogans, motifs, patterns and/or the like. the digital content may further include virtual items, i.e., digital representation of items which may exist and/or used in the virtual domain, for example, by avatars in the virtual environments/worlds.

Users interacting with the virtual domain may therefore accumulate digital assets comprising the digital content and/or the virtual items. Moreover, the users may often wish to have, create and/or obtain physical items corresponding to the digital assets of the virtual domain.

### SUMMARY OF THE INVENTION

According to a first aspect of the present invention there is provided a method of generating smart contracts configured to distribute production instructions of physical items based on authentication of ownership of a corresponding digital assets, comprising using one or more processors for
Receiving a request, via one or more networks, from one or more client devices used by one or more users to produce one or more physical items corresponding to a digital asset of the one or more users.
Transmitting a unique key to the one or more client devices. The key is uniquely associated with the digital asset.
Generating a smart contract associating production instructions for producing the one or more physical items with the unique key. The smart contract is configured to provide the production instructions to the one or more users based on authentication of the unique key, Wherein the one or more users interact with the smart contract using the unique key to authenticate his ownership of the digital asset and receive the production instructions for producing the one or more physical items.

According to a second aspect of the present invention there is provided a system for generating smart contracts configured to distribute production instructions of physical items based on authentication of ownership of a corresponding digital asset, comprising a non-transitory storage medium storing a code, and one or more processors coupled to the non-transitory storage medium. The one or more processors are configured to execute the code. The code comprising:
Code instructions to receive one or more requests, via one or more network, from one or more client device used by one or more user to produce one or more physical item corresponding to a digital asset of the one or more user.
Code instructions to transmit a unique key to the one or more client device. The key is uniquely associated with the digital asset.
Code instructions to generate a smart contract associating production instructions for producing the one or more physical item with the unique key. The smart contract is configured to provide the production instructions to the one or more user based on authentication of the unique key,
   Wherein the one or more user interacts with the smart contract using the unique key to authenticate his ownership of the digital asset and receive the production instructions for producing the one or more physical item.

In a further implementation form of the first and/or second aspects, the one or more physical items comprise one or more apparel items and the production instructions comprise instructions adapted for one or more textile printers for printing a design on the one or more apparel items.

In a further implementation form of the first and/or second aspects, the one or more physical items comprises one or more apparel items and the production instructions comprise instructions adapted for one or more apparel production systems for producing the one or more apparel items.

In a further implementation form of the first and/or second aspects, the one or more physical items comprises one or more Three Dimensional (3D) items and the production instructions comprise instructions adapted for one or more 3D printer for printing the one or more 3D items.

In an optional implementation form of the first and/or second aspects, the digital asset comprises one or more digitally represented designs associated with the one or more users.

In a further implementation form of the first and/or second aspects, the one or more digitally represented designs are members of a group consisting of: a picture, a drawing, a symbol, an icon, a text, a slogan, a motif, and/or a pattern.

In an optional implementation form of the first and/or second aspects, the digital asset comprises one or more virtual items used by one or more virtual avatars associated with the one or more users.

In a further implementation form of the first and/or second aspects, the smart contract is recorded in a blockchain controlled by a decentralized network of a plurality of computing nodes.

In a further implementation form of the first and/or second aspects, the unique key comprises a non-fungible token (NFT) recorded in the blockchain in association with the digital asset.

In a further implementation form of the first and/or second aspects, the unique key comprises a private key and a respective public key derived from the private key, the public key is included in the smart contract, the private key is used by the one or more users to encrypt one or more messages decodable using the public key thus authenticating the user as the originator of the one or more encrypted messages.

In a further implementation form of the first and/or second aspects, the smart contract defines a maximal number of copies of the one or more physical items.

In an optional implementation form of the first and/or second aspects, the production instructions further comprising instructions to print one or more authentication designs on the one or more physical items. The one or more authentication designs are defined by the smart contract.

In a further implementation form of the first and/or second aspects, the one or more authentication designs encode information defined by the smart contract.

In a further implementation form of the first and/or second aspects, the production instructions define printing the one or more authentication designs using one or more paint materials visible to human eye.

In a further implementation form of the first and/or second aspects, the production instructions define printing the one or more authentication designs using one or more paint materials invisible to human eye.

In a further implementation form of the first and/or second aspects, the production instructions define printing the one or more authentication designs such that the one or more authentication designs are embedded in one or more design features printed on the one or more physical items such that the one or more authentication designs are indiscernible by human eye from the one or more design features.

In a further implementation form of the first and/or second aspects, the production instructions further comprising instructions to encode information defined by the smart contract in one or more authentication devices coupled to the one or more physical items.

In a further implementation form of the first and/or second aspects, the smart contract is configured to enable adjustment of the production instructions to customize one or more production features of the one or more physical items.

In an optional implementation form of the first and/or second aspects, the smart contract is created in advance independently of a request from the one or more users and transmitting the unique key to the one or more users in response to a production request received from the one or more users.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks automatically. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of methods and/or systems as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars are shown by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of an exemplary process of generating smart contracts to control distribution of production instructions for producing physical items corresponding to digital assets, according to some embodiments of the present invention;

FIG. 2 is a schematic illustrations of an exemplary system for generating smart contracts to control distribution of production instructions for producing physical items corresponding to digital assets, according to some embodiments of the present invention;

FIG. 3 is a flowchart of an exemplary process of distributing production instructions according to smart contracts configured to verify ownership of corresponding digital assets by the users, according to some embodiments of the present invention;

FIG. 4 is a schematic illustration of an exemplary sequence for producing a physical item for a user based on successful verification of ownership of the user as defined by a smart contract, according to some embodiments of the present invention; and

FIG. 5 is a schematic illustration of producing a physical item duplicating a respective virtual item owned by a user, according to some embodiments of the present invention.

### DESCRIPTION OF SPECIFIC EMBODIMENTS OF THE INVENTION

The present invention, in some embodiments thereof, relates to generating smart contracts to control distribution of production instructions for producing physical items for users based on verification of ownership of corresponding digital assets by the users.

According to some embodiments of the present invention, there are provided methods, systems and computer program products for generating smart contracts configured to automatically control distribution of production instructions for producing physical items corresponding to digital assets.

As known in the art, each smart contract may be configured to automatically execute, control or document actions, operations and/or events according to terms, definitions, conditions, criteria, events and/or the like defined by the smart contract.

After created, the smart contracts may be deployed for execution by one or more computing devices, for example, a device, a system, a computing node, a cluster of computing nodes, a cloud service and/or platform and/or the like.

Moreover, as known in the art, one or more of the smart contracts may be recorded in a blockchain based distrusted ledger controlled by a decentralized network of a plurality of independent computing nodes. In such deployments, the blockchain constructed of a plurality of immutable irreversible blocks, may be controlled by the plurality of computing nodes each holding (storing) and maintaining a respective local copy of the distrusted ledger. The computing nodes communicating with the other via one or more networks may employ one or more consensus algorithms and/or protocols as known in the art to synchronize and update their local ledger copies based on a majority consensus among themselves.

Users owning digital assets in virtual domain may wish to produce corresponding physical items in the physical real world, for example, apparel items (e.g. cloths, footwear, hats, etc.), accessories, jewelry, tools, gadgets, and/or the like. Producing corresponding physical items may comprise printing one or more designs (e.g. picture, drawing, pattern, symbol, icon, slogan, etc.) relating to the digital asset(s) of the user on one or more existing physical items. However, producing the corresponding physical items may also include actually producing one or more physical items according to the digital asset(s) of the user which may further comprise printing on the produced physical item(s).

The digital assets owned, at least temporarily, by the users may comprise digital content, for example, digitally represented designs (e.g. picture, drawing, symbol, icon, slogan, etc.), virtual items and/or the like. The users may obtain (e.g. purchase, receive, win, inherit, etc.) the digital assets from one or more resources in the virtual domain, for example, an online marketplace, a virtual environment and/or virtual world (e.g. Metaverse, Fortnite, Robolox, etc.), and/or the like.

In order comply with ownership rights and prevent fraudulent and/or false production of the physical items, the smart contracts may be configured to distribute, in response to requests from one or more of the users, production instructions for producing one or more physical items corresponding to one or more respective digital assets based on verification of ownership of the digital assets by the requesting users.

The smart contracts may be therefore adapted to first verify ownership of the digital assets by the requesting users and distribute the production instruction for producing the corresponding physical items only in case the digital assets ownership is successful verified.

To this end, each smart contract may include a unique key generated and assigned to each requesting user which is indicative that a certain digital asset id owned by the respective user. the unique key may be implemented using, for example, a Non-Fungible Token (NFT) assorting the requesting user with the certain digital asset. The NFT which may be recorded in a blockchain may be thus used to verify ownership of the certain digital asset by the respective user. In another example, the unique key may be implemented using a private-public key pair as known in the art. The private key may be secret such that only the user has it while the public key which is derived from the private key may be publicly distributed and specifically included in the smart contact.

In order to produce one or more physical items corresponding to the certain digital asset, the user may use his assigned unique key to interact with the smart contact executed automatically by the computing nodes in order to request and obtain the production instructions.

In response, the smart contact may authenticate the unique key to verify that the requesting user legitimately owns the certain digital asset. For example, in case the unique key comprises an NFT, the requesting user may provide the NFT or a pointer (link) to the NFT such that the smart contract may check the NFT to determine whether the requesting user indeed owns the certain digital asset. In another example, assuming the unique key implements a private-public key, the user may transmit to the smart contact one or more messages encrypted and/or signed using his assigned private key. The smart contract may attempt to decrypt the message(s) using the public key associated with the requesting user and in case of successful decryption may determine that the requesting user is the owner of the certain digital asset.

Finally, in case of successful authentication of the unique key the smart contract may distribute the production instructions for producing one or more physical items corresponding to the certain digital asset.

The production instructions may comprise instructions adapted for one or more production systems, for example, a printer, a textile printer, a 3 Dimensional (3D) printer, a Computer Numerical Control (CNC) machine, an industrial production system, a manufacturing facility and/or the like. For example, assuming the physical item is an apparel item, for example, a shirt and the digital asset is a certain design, for example, a certain geometric pattern. In such case, the production instructions may comprise instructions adapted to one or more textile printers for printing the certain geometric pattern on the shirt.

Optionally, the smart contact may be configured to enable the user to alter and/or adjust one or more production features, for example, color, size, proportion, print area of the digital asset, and/or the like to customize the physical item(s) produced accordingly.

Optionally, the production instructions may further comprise instruction for printing on the physical items one or more authentication designs encoding authentication information which may be used to authenticate the produced physical items and verify they are genuine and not fake items. One or more of the authentication designs may be printed such that they are visible to the human eye and thus and identifiable to verify they are genuine. However, one or more of the authentication designs may be invisible to the human eye such that one or more sensors, for example, an Infrared (IR) sensor, an Ultra Violet (UV) sensor and/or the like may be used to identify the authentication design(s) and extract the authentication information to verify the physical item is genuine. Moreover, one or more of the authentication designs may be embedded in one or more design features printed on one or more of the physical items such that the authentication design(s) is indiscernible by human eye from the printed design features.

Optionally, the production instructions may further comprise instruction for encoding the authentication information in one or more authentication devices, for example, a Radio Frequency Identification (RFID) device, a Near-Field Communication (NFC) device and/or the like coupled to one or more of the produced physical items.

Creating the smart contracts configured to automatically control distribution of production instructions, in response to requests from users, for producing physical items corresponding to digital assets of the requesting users subject to verification of their ownership may present significant advantages and benefits.

First, using the smart contracts configured to verify ownership of the digital assets by requesting users may ensure that ownership rights are enforced thus significantly reducing and potentially completely preventing abuse of the ownership rights by potential malicious parties who may falsely obtain the production instructions in attempt to produce the physical items.

Moreover, deployment of the smart contracts which may automatically control the distribution of the production instructions and thus of the production of the physical items may significantly reduce effort, computing resources (e.g. processing resources, storage resources, networking resources, etc.), time and/or manual labor which may be otherwise required to verify that the requesting users are indeed the legitimate owners of the digital assets for which corresponding physical items are requested to be produced.

The automated smart contracts may also significantly improve the technology of computer based applications for production instructions delivery by deploying automated and independent entities, namely the smart contacts which are constantly available and fully operational and are thus not subject to limiting operational conditions, hours, availability and/or access as may be the case for other automated and/or at least partially manual applications and/or services. The user experience of the users who may interact with the smart contacts with no time, availability, and/or access restrictions may be therefore significantly improved.

The user experience of the users may be further improved since the smart contacts may be configured to include production instructions for producing one or more physical items corresponding to multiple digital assets owned by a user collected from a plurality of online resources (e.g. online marketplaces, virtual worlds, etc.). Accumulating a plurality of digital assets to produce the production instructions for producing corresponding physical items may be significantly time and/or effort consuming, resource consuming and/or the like and in many scenarios may be impossible to accomplish by any single vendor of the digital assets.

Furthermore, recording the smart contracts in a blockchain may significantly increase transparency, reliability, robustness and/or immunity of the smart contacts to potential malicious attempts to falsely produce physical items corresponding to digital assets owned by legitimate users which may violate the users' ownership and/or proprietary rights.

In addition, using unique codes, for example, blockchain recorded NFTs may serve to reliably, accurately and securely record ownership of digital assets by users since such NFTs may be practically impossible to fraudulently forge, duplicate, imitate and/or otherwise compromise.

Also, encoding authentications information in authentications designs printed on the physical items and/or in authentications devices coupled to the physical items may significantly increase brand safety and confidence that the physical items are genuine rather than counterfeit items falsely produced in attempt to falsely appear as genuine items.

Optionally, the authentications information encoded in the authentications design(s) printed on the physical items and/or in the authentications device(s) coupled to the physical items may be used for one or more access applications. For example, the authentications information may encode a (private) key assigned to the user associated with the physical item (e.g. wearing, carrying, etc.) which may be used to identify the associated user and grant him access to one or more locations, resources and/or the like. For example, the key encoded in the printed authentications design(s) may be used as an entrance key for entering one or more restricted areas. In another example, the private key encoded in the printed authentications design(s) may be used as an entrance key for accessing one or more services, for example, financial services (e.g. ATM, online banking account, online credit/debit card service, etc.), and/or the like.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer program code comprising computer readable program instructions embodied on a computer readable medium may be transmitted using any appropriate medium, including but not limited to wireless, wire line, optical fiber cable, RF, etc., or any suitable combination of the foregoing.

The computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The computer readable program instructions for carrying out operations of the present invention may be written in any combination of one or more programming languages, such as, for example, assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

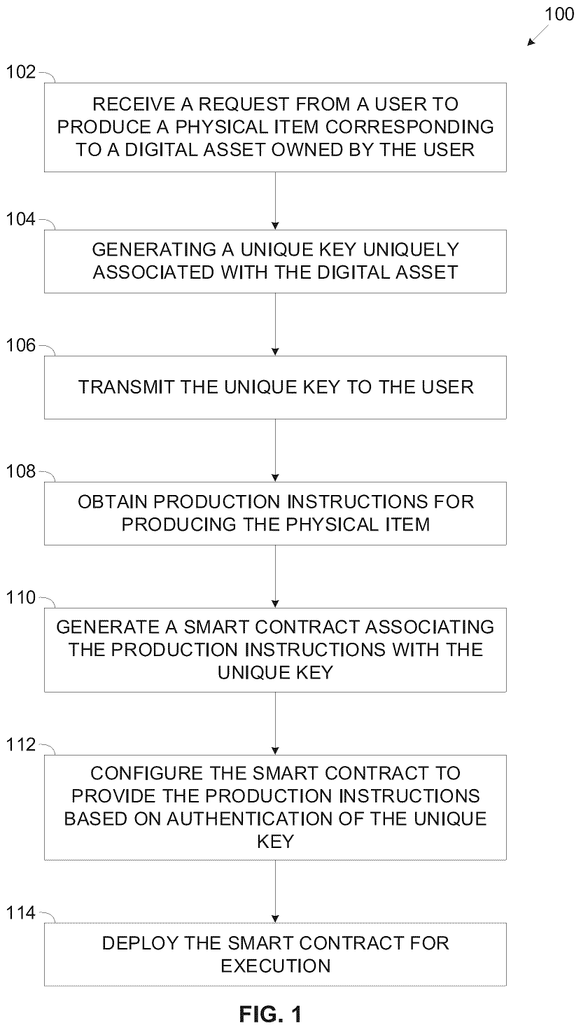

Referring now to the drawings, FIG. 1 is a flowchart of an exemplary process of generating smart contracts to control distribution of production instructions for producing physical items corresponding to digital assets, according to some embodiments of the present invention.

An exemplary process 100 may be executed to create one or more smart contracts configured to automatically control distribution of production instructions to one or more users. The production instructions may be used to produce one or more physical items corresponding to one or more digital assets owned by the users.

The smart contracts may be therefore configured to first verify ownership of the digital assets by the users and distribute the production instruction to the users based on the ownership verification. In particular, the smart contracts may be configured to verify the users' ownership by authenticating a unique key provided by each user, for example, an NFT, a code and/or the like associated with each digital asset.

The smart contracts may be executed by one or more devices, systems, platforms and/or services configured to automatically execute, control or document actions, operations and/or events according to terms, definitions, conditions, criteria, events and/or the like defined by each smart contract.

Moreover, one or more of the smart contracts may be recorded in a blockchain distrusted ledger controlled by a decentralized network of a plurality of computing nodes which is constructed, as known in the art, of a plurality of immutable irreversible blocks. The computing nodes each holding (storing) and maintaining a respective local copy of the distrusted ledger may communicate with the other computing nodes to synchronize and update their local ledger copies based on consensus among the computing nodes as known in the art.

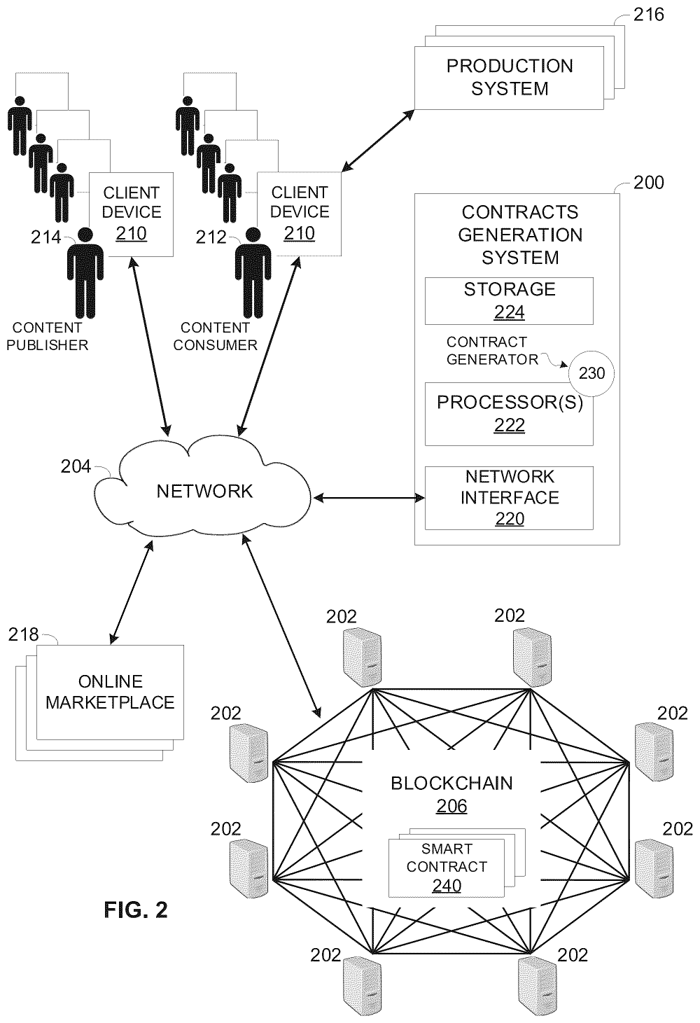

Reference is also made to FIG. 2, which is a schematic illustration of an exemplary system for generating smart contracts to control distribution of production instructions for producing physical items corresponding to digital assets, according to some embodiments of the present invention.

An exemplary contracts generation system 200, for example, a computer, a server, a processing node, a cluster of computing nodes and/or the like may be adapted to generate one or more smart contracts 240 configured to distribute production instructions for producing one or more physical items.

The smart contacts 240 each defining one or more actions, operations and/or events typically coupled with one or more terms, definitions, conditions, criteria, events and/or the like, may be automatically executed by one or more computing nodes 202, for example, a computer, a server, a processing node, a network node, a cloud computing resource, a Smartphone, a tablet and/or the like.

The contracts generation system 200 may communicate with the computing nodes 202 via a network 204 comprising one or more wired and/or wireless networks, for example, a Local Area Network (LAN), a Wide Area Network (WAN), a Municipal Area Network (MAN), a Wireless LAN (WLAN), a cellular network, the internet and/or the like.

Each smart contract 240 may be constructed of one or more software modules comprising a plurality of computer program instructions executable by one or more processing devices such as, for example, one or more of the computing nodes 202.

Optionally, one or more of the smart contracts 240 may be recorded and logged in a blockchain 206 controlled by a decentralized network of a group of computing nodes 202 communicating with each other via the network 204. The blockchain 206 may comprise a plurality of immutable and irreversible blocks of a distributed ledger as known in the art. The computing nodes 202, each holding (storing) and maintaining a respective local copy of the distrusted ledger, may communicate with each using one or more consensus algorithms and/or protocols as known in the art to synchronize and update their local ledger copies. In such case, the smart contracts 240 may be executed and collectively controlled by the group of computing nodes 202 according to a consensus among them.

One or more content publishers 214, for example, a content creator, a content seller, a content distributer and/or the like using respective client devices 210, for example, a computer, a server, a Smartphone, a tablet and/or the like may upload, via the network 204, one or more digital assets to one or more online marketplaces 218.

The content publishers 214 may upload the digital assets to the online marketplace(s) 218 and offer the digital items to one or more users 212, specifically content consumers typically in exchange to a payment, a service, a compensation and/or the like. The users 212 may use respective client devices 210 to access the online marketplace(s) 218 via the network 204.

The digital assets may include, for example, a digitally represented design such as, for example, a picture, a drawing, a symbol, an icon, a text, a slogan, a motif, a pattern and/or the like. In another example, the digital assets may include one or more NFTs.

The online marketplaces 218 may include, for example, one or more e-commerce shopping arenas, for example, OpenSea, Decentraland, and/or the like where digital assets may be offered for sale.

In another example, the online marketplaces 218 may include one or more websites, applications and/or the like executing a virtual environment and/or virtual world, for example, Metaverse, Robolox, Fortnite, and/or the like in which one or more of the users 212 may have respective avatars. The avatars associated with one or more of the users 212 may use one or more virtual items, for example, an apparel, an accessory, a tool, a gadget and/or the like. Moreover, such virtual environments may further serve as online marketplaces 218 in which one or more digital assets, for example, the virtual items may be offered to the users 212.

One or more users 212 each owning one or more digital assets may request the contracts generation system 200 for production instructions to produce one or more physical items corresponding to the digital asset(s) of the respective user 212. The production instructions may define production, for example, production, printing, fabrication and/or the like of one or more physical items by one or more production systems 216, for example, a printer, a textile printer, an apparel production system, a 3D printer, a CNC machine, a factory, a manufacturing site and/or the like.

For example, the physical items may comprise one or more apparel items, for example, cloths (e.g. shirt, pants, dress, jacket, swimsuit, hat, sock, tie, etc.), footwear (shoes, boots, sandals, etc.) and/or the like. In such case, the production instructions may comprise instructions adapted for one or more textile and/or leather printers for printing one or more designs on the apparel item(s) and/or on the material (e.g., fabric, leather, etc.). While the printing may typically include applying one or more ink materials on the physical items, the printing may further include creating one or more designs on the physical items, for example, carving, mold, forge and/or the like.

In another example, the physical items may comprise one or more 3D items, for example, jewelry, footwear, a tool, a gadget and/or the like. In such case, the production instructions may comprise instructions adapted for one or more 3D printers for printing the 3D items.

The contracts generation system 200 may comprise at least a network interface 220 for connecting to the network 204, a processor(s) 222 for executing the process 100, and a storage 224 for storing data and/or code (program store).

The contracts generation system 200 may communicate, via the network interfaces 220 connecting to the network 204, with the client devices 210 used by one or more of the content publishers 214 and/or by one or more of the users 212. Via the network 204, the contracts generation system 200 may further communicate with the blockchain 206, specifically with one or more of the computing devices 202 forming the decentralized network controlling the blockchain 206. Via the network, the contracts generation system 200 may also communicate with one or more other resources connected to the network 206, for example, the online marketplace(s) 218, the production system(s) 216 and/or the like.

The processor(s) 222, homogenous or heterogeneous, may include one or more processing nodes arranged for parallel processing, as clusters and/or as one or more multi core processor(s). The storage 224 may include one or more non-transitory memory devices, either persistent non-volatile devices, for example, a ROM, a Flash array, a hard drive, an SSD, and/or the like as well as one or more volatile devices, for example, a RAM device, a cache memory and/or the like. The storage 224 may further comprise one or more local and/or remote network storage resources, for example, a storage server, a Network Attached Storage (NAS), a network drive, a cloud storage service and/or the like accessible via the network interface 220.

The processor(s) 222 may execute one or more software modules, for example, a process, a script, an application, an agent, a utility, a tool, an Operating System (OS), a service, a plug-in, an add-on and/or the like each comprising a plurality of program instructions stored in a non-transitory medium (program store) such as the storage 224 and executed by one or more processors such as the processor(s) 222.

Optionally, the processor(s) 222 includes, utilizes and/or applies one or more hardware elements available in the contracts generation system 200, for example, a circuit, a component, an Integrated Circuit (IC), a Field Programmable Gate Array (FPGA), an Application Specific Integrated Circuit (ASIC), a Digital Signals Processor (DSP), a Graphic Processing Unit (GPU), an Artificial Intelligence (AI) accelerator and/or the like.

The processor(s) 222 may therefore execute one or more functional modules utilized by one or more software modules, one or more of the hardware modules and/or a combination thereof. For example, the processor(s) 222 may execute a contract generator 230 configured to execute the process 100 for generating one or more smart contracts 240 each defining distribution of production instructions for producing one or more physical items corresponding to digital assets owned by one or more of the users 212.

Optionally, the contracts generation system 200 and/or the contract generator 230 may be utilized by one or more cloud computing services, platforms and/or infrastructures such as, for example, Infrastructure as a Service (IaaS), Platform as a Service (PaaS), Software as a Service (SaaS) and/or the like provided by one or more vendors, for example, Google Cloud, Microsoft Azure, Amazon Web Service (AWS) and Elastic Compute Cloud (EC2), IBM Cloud, and/or the like.

For brevity, the process 100 is presented and described for generating a single smart contract 240 configured to control distribution of production instructions for producing a single physical item corresponding to a single digital asset owned by a single user 212. This, however, should not be construed as limiting since, as may be apparent to a person skilled in the art, the process 100 may be easily expanded for generating multiple smart contracts 240 each configured to control distribution of production instructions for producing one or more physical items corresponding to one or more digital asset owned by one or more users 212.

As shown at 102, the process 100 starts with the contracts generation system 200, for example, the contract generator 230 receiving a request from a user 212 to produce a physical item corresponding to a digital asset of the users 212, i.e., a digital asset owned by the user 212.

As described herein before, the digital assets may include, for example, a digitally represented design such as, for example, a picture, a drawing, a symbol, an icon, a text, a slogan, a motif, a pattern and/or the like. In another example, the digital assets may include one or more NFTs. In another example, the digital asset may include one or more virtual items used in one or more of the virtual environments.

The user 212 may acquire and own the digital asset through one or more actions, interactions and/or transactions. For example, the user 212 may purchase the digital asset in one or more of the online marketplaces 218. In another example, the user 212 may be a creator of the digital asset, for example, a digitally represented design. In another example, the user 212 may receive the digital asset as a reward for one or more services, actions, gestures, competitions, raffles and/or the like. In another example, the user 212 may receive the digital asset as a gift from one or more other users 212, entities and/or services.

As described herein before, the physical item may include, for example, one or more apparel items, for example, cloths, footwear, and/or the like. In another example, the physical items may comprise one or more 3D items.

The user 212 may thus wish to produce a physical item corresponding to his digital asset. As stated herein before, producing the corresponding physical item may comprise printing one or more designs (e.g. picture, drawing, pattern, symbol, icon, slogan, etc.) defined by and/or related to the digital asset of the user 212 on one or more existing physical items. However, producing the corresponding physical item may include producing the physical items according to the corresponding digital asset which may also include printing one or more designs corresponding to the digital asset of the user 212.

For example, assuming the use 212 owns a certain digitally represented design, for example, a certain drawing. In such case, the user 212 may wish to produce a certain physical item, for example, a hat printed with the certain drawing. In another example, assuming the use 212 purchased a certain virtual item for example, a certain T-shirt for an avatar of the user 212 in a certain virtual environment, for example, Metaverse. In such case, the user 212 may wish to produce a twin physical item of the certain virtual item, i.e., a physical T-shirt which may be used in the real world.

As shown at 104, the contract generator 230 may generate a unique key uniquely and exclusively associated with the digital asset. Moreover, the key may be indicative of ownership of the digital asset by a user 212 holding (having) the key.

The unique key may include, for example, an NFT recorded on a blockchain such as the blockchain 206 which may be indicative of ownership of the digital asset by the user 212. As known in the art, the blockchain recorded NFT used as the unique key may provide efficient, reliable, and/or robust proof of ownership of the digital asset by the user 212 which is fraud and/or impersonation resistant.

In another example, the unique key may comprise, a unique code, a password and/or the like. For example, the unique key may include a private-public key pair comprising a private key and a respective public key derived from the private key.

As shown at 106, the contract generator 230 may transmit the unique key to the user 212.

For example, assuming the unique key generated by the contract generator 230 comprises the NFT(s) recorded in the blockchain 206, the contract generator 230 may transmit the NFT(s) to the user 212 and/or inform the user 212 which NFT(s) were created to indicate the ownership of the digital asset by the user 212.

In another example, assuming the unique key generated by the contract generator 230 comprises the private-public key pair, the contract generator 230 may transmit the private key to the user 212. Optionally, the contract generator 230 apply one or more encryption, ciphering and/or other secure communication algorithms to securely transmit the private key to the user 212 such that the private key may not be intercepted and/or otherwise compromised by one or more potentially malicious parties attempting to fraudulently and falsely acquire ownership of the digital asset.

As shown at 108, the contract generator 230 may obtain production instructions for producing the physical item corresponding to the digital asset owned by the user 212.

As described herein before, the production instructions may be adapted for producing the physical item by one or more production systems such as the production systems 216 according to one or more attributes, parameters and/or characteristics of the physical item, for example, a type of the physical item, a type of a design printed on the physical item and/or the like.

For example, in case the physical item comprises one or more apparel items, the production instructions may comprise instructions adapted for the textile and/or leather printer(s) for printing one or more designs on the apparel item(s) and/or on the material used to produce the apparel item(s). In another example, assuming the physical item comprises one or more 3D items, the production instructions may comprise instructions adapted for the 3D printer(s) for printing the 3D item(s).

The contract generator 230 may obtain the production instructions from one or more sources and/or resources. For example, one or more storage resources accessible via the network 204 may comprise the production instructions which may be fabricated manually by one or more users, for example, an expert, a manufacturer, and/or the like and/or automatically by one or more automated systems, services, algorithms and/or the like.

In another example, the contract generator 230 may optionally generate, compute and/or determine the production instructions according to one or more guides, rules and/or templates predefined for the digital asset and/or for the physical item.

In another example, the production system(s) 216 may already have production instructions for producing the physical item. In such case, the production instructions created by the contract generator 230 may include an authorization and/or a “GO” command instructing the production system(s) 216 to produce the physical item.

Moreover, the production instructions may comprise instructions for printing one or more designs relating to and/or defined by the digital asset of the user 212 on an existing physical item. Alternatively, and/or additionally, the production instructions may comprise instructions for actually producing the physical item according to the digital asset of the user 212 which may further include printing one or more designs relating to and/or defined by the digital asset of the user 212 on the produced physical item.

For example, the production instructions may comprise instructions for printing a certain design, for example, a certain logo on a certain existing physical item, for example, a T-shirt which is already produced and materialized and is ready for printing. In such case, the production instructions may comprise instructions adapted for one or more printers configured to print on fabric. However, the production instructions may comprise instructions for producing the T-shirt and further printing the logo on the produced T-shirt. In such case, the production instructions may comprise instructions adapted for one or more apparel production systems configured to produce T-shirts and further print instructions for printing the certain logo on the T-shirt. Such print instructions may further comprise instructions, adapted for one or more textile printers, for printing the certain logo pre-production of the T-shirt (i.e., cutting, sawing, etc.) on one or more materials, for example, fabric and/or the like used to produce the T-shirt. In another example, the production instructions may further comprise instructions, adapted for one or more printers configured to print on fabric, for printing the certain logo on the T-shirt post-production of the T-shirt after it is cut, sawed, and/or the like.

As shown at 110, the contract generator 230 may generate a smart contract 240 comprising the production instructions for producing the physical item corresponding to the digital asset owned by the user 212. In particular, the smart contract 240 created by the contract generator 230 may associate the production instructions of the physical item with the unique key indicative of ownership of the corresponding digital asset by the user 212.

The contract generator 230 may configure the smart contract 240 to define one or more actions, operations and/or events, collectively designated actions, typically conditioned by one or more terms, definitions, conditions, criteria, events and/or the like, collectively designated conditions. As such, when the smart contract 240 is executed, one or more of the actions may be initiated and/or executed in case the condition(s) defined for these actions is detected, i.e., valid, met fulfilled and/or the like.

Specifically, as shown at 112, the smart contract 240 may define distribution, i.e., delivery and/or transmittal of the production instruction based on authentication and verification of the unique key associated with the digital asset and indicative of ownership of the digital asset. In other words, distribution of the production instructions for producing the physical item corresponding to the digital asset is subject to successful authentication and verification of the unique key provided by the user 212 to prove his ownership of the digital asset.

The contract generator 230 may therefore include in the smart contract 240 the unique key associated with the digital asset and/or an indication of the unique key. For example, assuming the unique key comprises the blockchain recorded NFT, the contract generator 230 may configure the smart contact to include the NFT and/or an indication (e.g., pointer, link, etc.) to the NFT. In another example, assuming the unique key comprises the private-public key pair, the contract generator 230 may configure the smart contact to include the public key of the pair which is derived from the private key transmitted to the user 212.

The contract generator 230 may configure the smart contract 240 to define one or more additional conditions. For example, the smart contract 240 may further define a maximal number of copies of the physical item to be produced by the production system(s) 216. The smart contact 240 may be further configured to record every production instructions distribution event and/or every production event of the physical item. The smart contract 240 may thus control and/or restrict production of the physical item according to one or more of the conditions, for example, the maximal number of copies of the physical item.

In another example, the production instructions included in the smart contract 240 may further comprise instructions to print one or more authentication designs on the one physical item. The authentication design(s), for example, a symbol, a pattern, a figure, a barcode, a QR code and/or the like may be defined by the smart contract 240.

The authentication design(s) may encode information defined by the smart contract 240. In particular, the information encoded in the authentication design(s) may include authentication information indicative that the physical item is an authentic item which may be differentiated and distinguished accordingly from a respective fake item. For example, the encoded authentication information may comprise a cryptographic signature which may not be duplicated or at least not accurately duplicated in a fake item and may be therefore used to verify that the physical item is authentic. In another example, assuming the production instructions define production of a batch of physical items, for example, 50 items. In such case, the encoded authentication information may include a copy number of each of the 50 physical items of the batch, i.e., each of the 50 physical items will be marked with a respective authentication design(s) indicative of the specific number of the respective physical item in the batch of 50 physical items.

The production instructions included in the smart contract 240 may define using one or more techniques and/or materials for printing the authentication design(s) on the physical item. For example, the production instructions may define printing the authentication design(s) using one or more paint materials which are visible to human eye, i.e., in the visible spectrum corresponding to a spectral range of approximately 350-750 nanometer. In another example, the production instructions may define printing the authentication design(s) using one or more paint materials which are invisible to human eye as they may reflect light in one or more spectral ranges invisible to the human eye, for example, IR (700 nanometers-1 millimeter), UV (10-400 nanometer), and/or the like. While invisible to the human eye, such invisible paint materials may be detected and identified using one or more sensors, specifically imaging sensors operable in the respective spectral ranges (e.g. IR, UV, etc.).

Moreover, the production instructions included in the smart contract 240 may define printing one or more of the authentication design(s) such that the authentication design(s) is embedded in one or more design features printed on the physical item. In particular, the production instructions may define printing the authentication design(s) such that the embedded authentication design(s) may be indiscernible by the human eye from the design feature(s) in which the authentication design(s) is embedded and thus invisible. The authentication design(s) may be detected and identified using one or more algorithms, filters and/or the like applied to one or more images depicting the design feature(s) embedding the authentication design(s).

The design features printed on the physical item may include, for example, a drawing, a picture, a pattern, a symbol, a barcode, a QR-code, and/or the like. The production instructions may therefore define printing the embedded authentication design(s) according to one or more parameters, attributes, and/or characteristics of the design features printed on the physical item. For example, assuming the design features printed on the physical comprise a certain pattern constructed of a plurality of fine lines, the production instructions may define printing a certain barcode authentication design embedded in the certain pattern. In another example, assuming the design features printed on the physical include a certain picture comprising a plurality of icons, the production instructions may define printing a certain icon authentication design embedded in the certain picture among the plurality of other icons.

Optionally, the production instructions included in the smart contract 240 may further comprise instructions to encode information, for example, authentication information in one or more authentication devices coupled to the physical item. The authentication information which may be defined by the smart contract 240 may comprise, for example, an identifier (ID) of the physical item, an ID of the digital asset corresponding to the physical item, an ID of the distributed (vendor) of the digital asset and/or the like. Moreover, the authentication information encoded in the authentication device(s) and/or part thereof may be encrypted and/or ciphered such that it may not be duplicated.

The authentication devices configured to store data may include, for example, one or more small form factor device s, for example, an RFID device, a Near Field Communication (NFC) device, and/or the like which may be attached, integrated and/or otherwise mechanically coupled to the physical item. Moreover, the authentication devices may comprise one or more battery-less devices which may intercept wireless energy as known in the art, for example, wireless network transmission signals, a magnetic field, and/or the like to drive their inner electrical circuitry to provide the authentication information encoded in them.

Optionally, the contract generator 230 may configure the smart contract 240 to support adjustment of the production instructions for customizing one or more production features of the physical item thus enabling the user 212 to customize one or more of production features of the physical item. The production features may include, for example, a color, a size, a proportion, a print area on the physical item and/or the like.

The smart contract 240 may be configured to support adjustment, selection and/or customization of the production feature(s) according to the physical item and/or the digital asset. For example, assuming the production instructions define production of a certain physical item, for example, a T-shirt printed with a certain symbol defined by the corresponding digital asset. In such case, the smart contract 240 may be configured to enable adjustment and/or selection of one or more production (print) features of the T-shirt, for example, one or more colors of the T-shirt. In another example, the smart contract 240 may be configured to enable adjustment and/or selection of one or more colors of the certain symbol. In another example, the smart contract 240 may be configured to enable adjustment and/or selection of one or more print area of the certain symbol on the T-shirt, for example, front, back, sleeve and/or the like. In another example, the smart contract 240 may be configured to enable adjustment and/or selection of a size of the certain symbol printed on the T-shirt.

As shown at 114, the contract generator 230 may deploy the smart contract 240 for execution by one or more of the computing nodes 202. For example, the smart contract 240 may be recorded in the blockchain 206 for collaborative execution by the group of computing nodes 202 which are part of the blockchain network. In another example, the smart contract 240 may be uploaded for execution by to one or more computing nodes 202, for example, a server, a cloud service and/or the like.

The user 212 who requested to produce the physical item may therefore interact with the smart contract 240 executed by the computing node(s) 202 to receive the production instructions for producing the physical item corresponding to the digital asset owned by the user 212. In particular, when interacting with the smart contract 240, the user 212 may provide the unique key he received from the contract generator 230 in order to authenticate his ownership of the digital asset as defined by the smart contract 240.

Based on the unique key authentication, the smart contract 240 may distribute the production instructions, i.e., provide the production instructions for producing the physical item corresponding to the digital asset. As such, in case of successful verification of the unique key, the smart contract 240 may distribute the production instructions while in case the authentication of the unique key fails, the smart contract 240 may prevent distribution of the production instructions. According to some embodiments of the present invention, the contract generator 230 may generate one or more smart contracts 240 in advance independently of production request(s) received from the any of the users 212 (content consumers), i.e., without explicit request from any of the users 212 to produce the physical item.

In such embodiments, the contract generator 230 may generate one or more smart contracts 240 for one or more digital assets transferrable to one or more of the users, for example, through sale, reward, gift and/or the like. Each such smart contract 240 may include production instructions for producing one or more physical items corresponding to the digital asset and may further associate the production instructions with a respective unique key as described herein before. The unique key however is not transmitted to any user 212.

Later on, when one or more of the users 212 wishes to produce one or more physical items corresponding to a certain digital asset that is owned by the respective user 212. The contract generator 230 may transmit the unique key to the user(s) 212 owning the digital asset.

Using the unique key, the user 212 may interact with the smart contract 240, as described herein before, to obtain the production instructions.

Optionally, the contract generator 230 may provide the unique key included in one or more of the smart contracts 240 to one or more distributers, for example, a manufacturer, a seller, an agent, and/or the like with whom one or more of the users 212 may interact to produce the physical item(s).

As described herein before, the smart contract 240 may be configured to define one or more additional conditions, for example, the maximal number of copies of the physical item and moreover, to record every production instructions distribution event and/or every event of producing the physical item. The smart contact 240 may therefore monitor, control, and/or restrict the number of physical items produced by the distributer(s) according to the conditions defined in the smart contact 240.

For example, assuming one or more distributes, for example, a manufacturer having production means, for example, a textile printer for producing physical items, for example, T-shirts printed with one or more designs corresponding to digital assets owned by one or more of the users 212. The contract generator 230 may create a certain smart contract 240 for producing T-shirts corresponding to a certain digital asset, for example, a certain logo. The contract generator 230 may further configure the certain smart contact 240 to define a maximal number of copies of the T-shirts that may be printed with the certain logo, for example, 100 copies. The contract generator 230 may also configure the certain smart contact 240 to track and record all production events of the printed T-shirts. The certain smart contact 240 may therefore control and restrict, to 100, the number of T-shirts printed with the certain logo that are produced by the distribute(s).

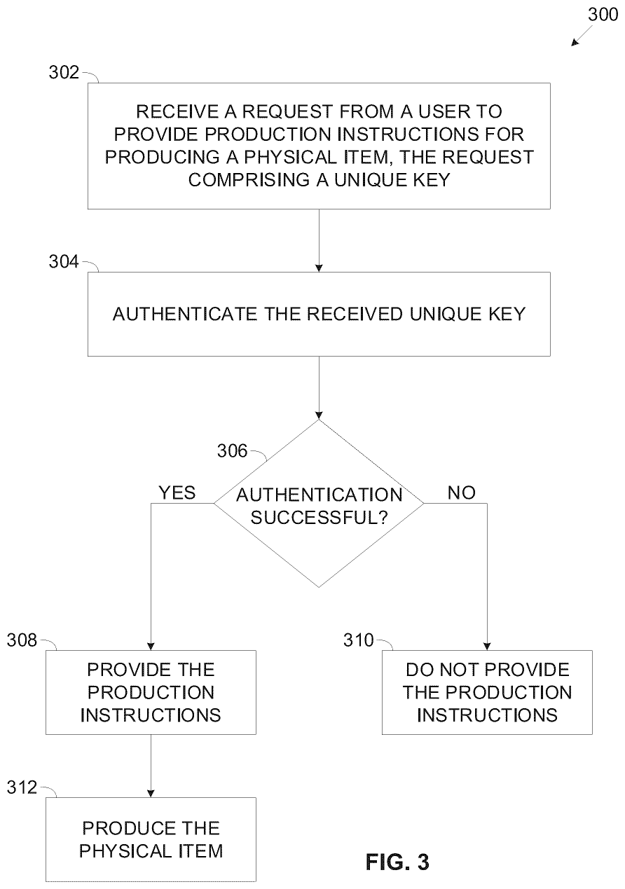

Reference is ow made to FIG. 3, which is a flowchart of an exemplary process of distributing production instructions according to smart contracts configured to verify ownership of corresponding digital assets by the users, according to some embodiments of the present invention.

An exemplary process 300 may be executed by one or more computing nodes such as the computing nodes 202 executing a smart contract such as the smart contract 240, for example, collaboratively executing the smart contract 240 recorded in a blockchain such as the blockchain 206 controlled by the blockchain network comprising at least a group of the plurality of computing nodes 202.

The smart contract 240 comprising production instructions for producing one or more physical items corresponding to one or more digital assets owned by a user such as the user 212 may associate the production instructions with a unique key generated for the user during the creation of the smart contract 240 as described in the process 100.

For brevity, the process 300 is described to be executed by the smart contact 240. However, as may be understood by a person skilled in the art, the process 300 is actually executed by computing node(s) 202 executing the smart contract 240. Moreover, for brevity, the smart contract 240 executing the process 300 is described to serve a single user 212 requesting to produce a single physical item corresponding to a single digital asset owned by the single user 212. This, however, should not be construed as limiting since, as may be apparent to a person skilled in the art, the process 300 may be easily expanded for serving a plurality of users 212 each requesting to produce one or more physical items corresponding to one or more digital assets owned by the respective user 212.

As shown at 302, the smart contract 240 may receive a request from a user 212 to produce a physical item corresponding to a digital asset owned by the user 212.

The request may comprise a unique generated by a contract generator such as the contract generator 230 executing a process such as the process 100 to generate the smart contract 240.

For example, assuming the unique key generated for the user 212 by the contract generator 230 comprises one or more NFTs recorded on a blockchain such as the blockchain 206 to indicate ownership of the digital asset by the user 212. In such case, the request may comprise the NFT, a link to the NFT, a pointer to the NFT and/or the like. In another example, assuming the unique key generated for the user 212 comprises a private-public key pair, where the secret private key is exclusively available (known) to the user 212 and the public key is included in the smart contract 240. In such case, the request may comprise one or more messages encrypted and/or signed using the private key of the user 212 and thus decodable using the public key derived from the secret private key of the pair

As shown at 304, the smart contract 240 may authenticate the unique key received from the user 212 in the request in order to verify ownership of the digital asset by the user 212. In other words, the smart contract may authenticate the unique key provided by the user 212 in order to verify that the user 212 is indeed the owner of the digital asset and may be therefore entitled to produce the physical item corresponding to the digital asset.

The smart contract may apply one or more methods, techniques and/or algorithms to authenticate the unique key. For example, assuming the unique key is implemented using the NFT(s), the smart contract 240 may analyze the NFT and extract the ownership information to determine whether the user 212 is the registered owner of the digital asset. In another example, assuming the unique key is implemented using the private-public key pair, the smart contact 240 may use its stored public key to decrypt the message(s) received from the user 212. Successful decryption of the message(s) using the public key associated with the user 212 may indicate that message(s) indeed originate from the user 212 and the smart contract 240 may thus successfully authenticate he unique key. However, if the decryption fails, the smart contact 240 meaning that authentication of the unique key fails, the smart contract 240 may determine that the 212 is not the owner of the digital asset and/or that the message(s) do not originate from the user 212 but rather from a potential malicious impersonator attempting to impersonate as of the user 212 in order to produce the physical item under falsely pretense of being the user 212.

As shown at 306, which is a conditional step, in case the smart contract 340 successfully authenticates the unique key received from the user 212, the process 300 may branch to 308. However, in case the smart contract 340 fails to authenticate the unique key, the process 300 may branch to 310.

As shown at 308, since the smart contract 340 successfully authenticates the unique key of the user 212, the smart contract 340 may distribute the production instructions for producing the physical item corresponding to the digital asset owned by the user 212. For example, the smart contract 240 may transmit the production instructions to the user 212 who may use the production instructions to produce the physical item. In another example, the smart contract 240 may transmit the production instructions and/or a production authorization (“GO”) to one or more production sites such as the production system 216, for example, a factory, a manufacturing facility and/or the like instructing them to produce the physical item.

As shown at 310, since the smart contract 340 failed to authenticate the unique key of the user 212, the smart contract 340 may prevent distribution of the production instructions since ownership of the digital asset by the user 212 cannot be varied.

As shown at 312, the physical item may be produced according to the production instructions distributed by the smart contract. For example, assuming the production instructions are transmitted to the users 212, the user 212 may use the production instructions to operate one or more production systems such as the production system 216, for example, a printer, a textile printer, a 3D printer, a CNC machine, and/or the like to produce the physical item. In another example, in case the production instructions and/or the production authorization are transmitted to the higher capacity production sites 216, the production sites 216 may produce the physical item according to the production instructions. Moreover, the physical item may be then delivered to the user 212.

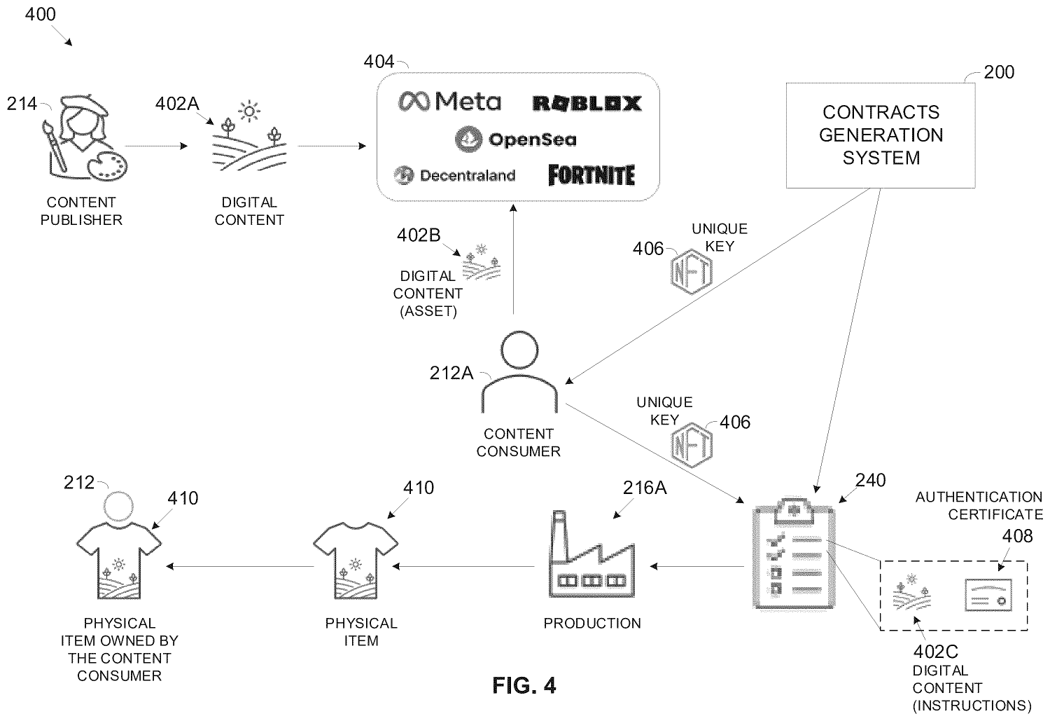

Reference is now made to FIG. 4, which is a schematic illustration of an exemplary sequence for producing a physical item for a user based on successful verification of ownership of the user as defined by a smart contract, according to some embodiments of the present invention.

An exemplary sequence 400 illustrates a purchase of an exemplary digital content 402A, for example, a drawing portraying a nature scene (fields, trees, sun) by a user 212A such as the user 212, specifically a content consumer 212A.

The digital content 402A created and/or published by a content publisher such as the content publisher 214 may be offered, presented and/or demonstrated in one or more online marketplaces 404 such as the online marketplace 218, for example, an e-commerce shopping arena (e.g., OpenSea, Decentraland, etc.), a virtual environment and/or a virtual world (e.g., Metaverse, Robolox, Fortnite, etc.) and/or the like.

The content consumer 212A visiting, browsing and/or exploring the online marketplace(s) 404 may purchase the digital content 402A thus making it his owned digital asset 402B.

The content consumer 212A may request to produce one or more physical items corresponding to the digital asset 402B, for example, a T-shirt 410 printed with the nature scene drawing portrayed in the digital asset 402B.

As described for the process 100, in response to the request from the content consumer 212A, a contracts generation system such as the contracts generation system 200 executing a contract generator such as the contract generator 230 may generate a smart contact such as the smart contract 240 comprising production instructions 402C for producing the T-shirt 410. In particular, the smart contract 240 may associate the production instructions 402C with a unique key, for example, an NFT 406 indicative of the ownership of the digital asset 402B by the content consumer 212A. The smart contract may therefore include the unique code implemented, for example, as an authentication certificate 408 associating the NFT 406 with the digital asset 402B. The authentication certificate 408 may be therefore used to authenticate the NFT 406 and thus verify the ownership of the digital asset 402B by the content consumer 212A.

The contract generator 230 may transmit the unique key, i.e., the NFT 406 to the content consumer 212A.

Moreover, the contract generator 230 may deploy the smart contract 240 for execution by one or more computing nodes such as the computing nodes 202.

The content consumer 212A may then interact with the smart contact 240 and provide the NFT 406 which may be authenticated by the smart contract 240 according to the authentication certificate 408.

In case the NFT 406 is authenticated successfully, the smart contract 240 may distribute the production instructions 402C for producing physical item, i.e., the T-shirt 410. For example, the smart contract 240 may transmit the production instructions 402C to a manufacturing site 216A such as the manufacturing system 216 which may apply the production instructions 402C to produce the T-shirt 410 and provide it to the user 212A who may use the physical item, for example, happily wear the T-shirt 410 printed with the nature scene drawing portrayed in the digital asset 402B.

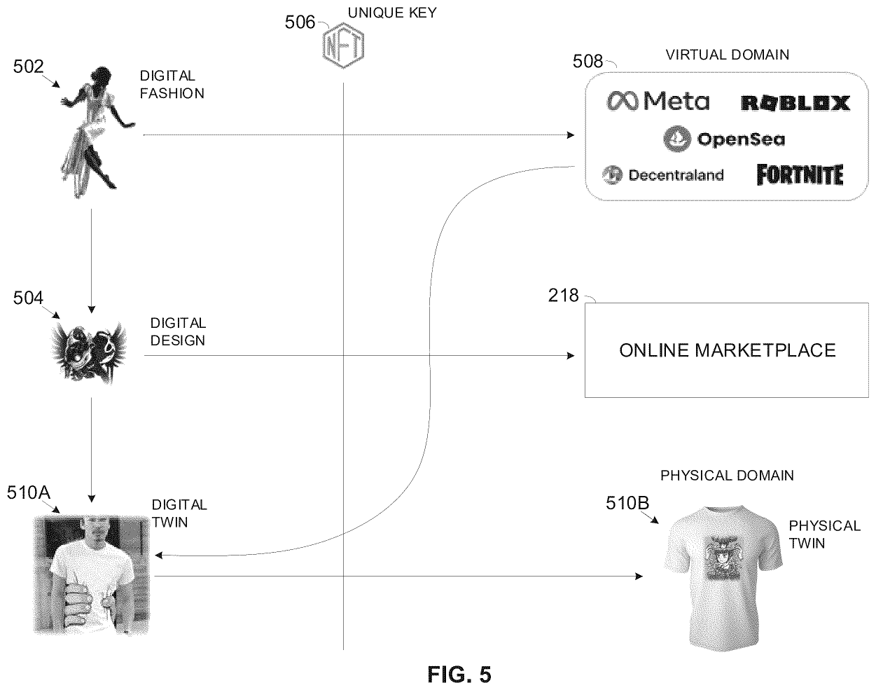

Reference is now made to FIG. 5, which is a schematic illustration of producing a physical item duplicating a respective virtual item owned by a user, according to some embodiments of the present invention.

An exemplary digital content, for example, a digital fashion item 502 created and/or published by a content publisher such as the content publisher 214 may be offered, presented and/or demonstrated in one or more virtual environments and/or virtual worlds, collectively designated virtual domain 508, for example, OpenSea, Decentraland, Metaverse, Robolox, Fortnite, and/or the like.

A content consumer such as the content consumer 212 exploring the virtual domain 508 may be exposed to the digital fashion item 502 and may purchase a digital asset at one or more online marketplaces such as the online marketplace 218, for example, a digital design 504 relating, for example, derived, corresponding, comprising and/or the like to the digital fashion item 502.

Moreover, the digital design 504 may be used to create a virtual item, for example, a digitally represented T-shirt 510A existing, i.e., seen, present and/or the like only in the virtual domain 508. Moreover, the virtual item, namely the virtual T-shirt 510A may be optionally used by an avatar associated with the content consumer 212 in one or more of the virtual environment and/or virtual worlds 404.

The content consumer 212 wishing to produce a physical twin, for example, a physical T-shirt 510B that is identical to the virtual T-shirt (digital twin) 510A and exists in the real world, i.e., in the physical domain.

To this end, in response to request from the content consumer 212, a process such as the process 100 may be executed by a contract generator such as the contract generator 230 executed by a contracts generations system such as the contracts generations system 200 to generate a smart contract such as the smart contract 240 comprising production instructions for producing the physical T-shirt 510B corresponding to the virtual T-shirt 510A.

As described herein before, the contract generator 230 may configure the smart contract 240 to associate the production instructions with a unique key, for example, an NFT 506 which is indicative of ownership of the digital design 504 and/or the virtual T-shirt 510A by the content consumer 212.

After created and deployed, the smart contract 240 may be executed by one or more computing nodes such as the computing nodes 202. The content consumer 212 interacting with the smart contract 240 may provide the NFT 506 to prove his ownership of the digital design 504 and/or the virtual T-shirt 510A. In case the smart contract 240 successfully authenticates the NFT 506 and verifies that the content consumer 212 is the registered owner of the virtual T-shirt 510A, the smart contract 240 may distribute the production instructions which may be applied by one or more production system such as the production system 216 to produce the physical twin T-shirt 510B.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems, methods and computer programs will be developed and the scope of the terms blockchain, distributed ledger, consensus algorithms and NFT are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method of generating smart contracts configured to distribute production instructions of physical items based on authentication of ownership of a corresponding digital assets, comprising:
using at least one processor for:
receiving a request, via at least one network, from at least one client device used by at least one user to produce at least one physical item corresponding to a digital asset of the at least one user;
transmitting a unique key to the at least one client device, the key is uniquely associated with the digital asset; and
generating a smart contract associating production instructions for producing the at least one physical item with the unique key, the smart contract is configured to provide the production instructions to the at least one user based on authentication of the unique key;
wherein the at least one user interacts with the smart contract using the unique key to authenticate his ownership of the digital asset and receive the production instructions for producing the at least one physical item.

2. The method of claim 1, wherein the at least one physical item comprises an apparel item and the production instructions comprise instructions adapted for at least one textile printer for printing a design on the apparel item.

3. The method of claim 1, wherein the at least one physical item comprises an apparel item and the production instructions comprise instructions adapted for at least one apparel production system for producing the apparel item.

4. The method of claim 1, wherein the at least one physical item comprises a three dimensional (3D) item and the production instructions comprise instructions adapted for at least one 3D printer for printing the 3D item.

5. The method of claim 1, further comprising the digital asset comprises at least one digitally represented design associated with the at least one user.

6. The method of claim 5, wherein the at least one digitally represented design is a member of a group consisting of: a picture, a drawing, a symbol, an icon, a text, a slogan, a motif, and a pattern.

7. The method of claim 1, further comprising the digital asset comprises at least one virtual item used by at least one virtual avatar associated with the at least one user.

8. The method of claim 1, wherein the smart contract is recorded in a blockchain controlled by a decentralized network of a plurality of computing nodes.

9. The method of claim 8, wherein the unique key comprises a non-fungible token (NFT) recorded in the blockchain in association with the digital asset.

10. The method of claim 1, wherein the unique key comprises a private key and a respective public key derived from the private key, the public key is included in the smart contract, the private key is used by the at least one user to encrypt at least one message decodable using the public key thus authenticating the user as the originator of the at least one encrypted message.

11. The method of claim 1, wherein the smart contract defines a maximal number of copies of the at least one physical item.

12. The method of claim 1, wherein the production instructions further comprising instructions to print at least one authentication design on the at least one physical item, the at least one authentication design is defined by the smart contract.

13. The method of claim 12, further comprising the at least one authentication design encodes information defined by the smart contract.

14. The method of claim 12, wherein the production instructions define printing the at least one authentication design using at least one paint material visible to human eye.

15. The method of claim 12, wherein the production instructions define printing the at least one authentication design using at least one paint material invisible to human eye.

16. The method of claim 12, wherein the production instructions define printing the at least one authentication design such that the at least one authentication design is embedded in at least one design feature printed on the at least one physical item such that the at least one authentication design is indiscernible by human eye from the at least one design feature.

17. The method of claim 1, wherein the production instructions further comprising instructions to encode information defined by the smart contract in at least one authentication device coupled to the at least one physical item.

18. The method of claim 1, wherein the smart contract is configured to enable adjustment of the production instructions to customize at least one production feature of the at least one physical item.

19. The method of claim 1, further comprising creating the smart contract in advance independently of a request from the at least one user and transmitting the unique key to the at least one user in response to a production request received from the at least one user.

20. A system for generating smart contracts configured to distribute production instructions of physical items based on authentication of ownership of a corresponding digital assets, comprising:
a non-transitory storage medium storing a code; and
at least one processor coupled to the non-transitory storage medium, the at least one processor is configured to execute the code, the code comprising:
code instructions to receive a request, via at least one network, from at least one client device used by at least one user to produce at least one physical item corresponding to a digital asset of the at least one user;
code instructions to transmit a unique key to the at least one client device, the key is uniquely associated with the digital asset; and
code instructions to generate a smart contract associating production instructions for producing the at least one physical item with the unique key, the smart contract is configured to provide the production instructions to the at least one user based on authentication of the unique key;
wherein the at least one user interacts with the smart contract using the unique key to authenticate his ownership of the digital asset and receive the production instructions for producing the at least one physical item.
